(19) United States
(12) Patent Application Publication
(10) Pub. No.: US 2010/0313197 A1
(43) Pub. Date: Dec. 9, 2010

(54) SYSTEM AND METHOD FOR OPERATING DOMAIN PROFILE USING DATABASE IN CORE FRAMEWORK FOR SDR MOBILE TERMINALS

(75) Inventors: Eunseon Cho, Daejeon (KR); Namhoon Park, Daejon (KR); Jinup Kim, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon-city (KR)

(21) Appl. No.: 12/745,517

(22) PCT Filed: Apr. 29, 2008
(86) PCT No.: PCT/KR2008/002419

§ 371 Date: May 28, 2010

(30) Foreign Application Priority Data
Nov. 30, 2007 (KR) 10-2007-0123303

(51) Int. Cl. G06F 17/30; G06F 9/445

(52) U.S. Cl. 717/174; 707/769; 707/E17.014

(57) ABSTRACT

Disclosed is a system and method for operating a domain profile using a database in a core framework for an SDR terminal. In the core framework for an SDR terminal, which has an SCA (software communications architecture)-based software structure, several managers record domain profiles required to install and execute applications on a database text file, instead of recording the domain profiles on an XML file, and then store the database text file in a database and manage the domain profile. When uploading an application to a terminal, the managers in the core framework for an SDR terminal load the database text file to the DB to execute the database text file, and then rapidly search the domain profile from the database. In this way, it is possible to reduce parsing time and improve the performance of a system.

### TECHNICAL FIELD

The present invention relates to a system and method of operating a domain profile, and more particularly, to a system and method for operating a domain profile using a database in a core framework for an SDR terminal.

The invention was supported by the IT R&D program of MIC/IITA [2006-S-012-02, Development of Middleware Platform Technology Based on the SDR Mobile Station].

### BACKGROUND ART

A software communications architecture (hereinafter, referred to as an SCA) is a standard communication software architecture that has been proposed by the Joint Tactical Radio System (JTRS) Joint Program Office (JPO) in order to improve interoperability between systems and to reduce development and arrangement costs. The SCA adopts CORBA (common object request broker architecture), which is an industrial standard for a real time operating system (RTOS) and a distributed object model, as middleware, thereby providing an integrated environment of different types of hardware and software. This is not a standard that is limited to a specific system, but an independent system design framework. An SCA-based system means a communication system having such an SCA structure. For example, an SDR (software defined radio) system adopts the SCA as a standard for a software framework.

In addition, the SCA applies information on hardware and software components to an XML DTD (document type definition) to describe a domain profile.

The domain profile is composed of descriptor files for describing hardware and software configuration information of the system. Among the descriptor files, a software package descriptor file includes information related to component implementation in order to arrange a corresponding component at a specific position of a device. The software package descriptor file including the component implementation information includes another software package descriptor file that defines a component in a library format, which should be loaded before the corresponding component is loaded or executed, that is, another software package descriptor file having a subordinate element. The subordinate software package descriptor file that defines component implementation information in a library format, which including the subordinate element, generally has an attribute that is defined by the software package descriptor file (main software package descriptor file) including such a file.

In the SCA, an application performs the function of one waveform. In addition, the application binds several components into one package and parses, installs, arranges, and executes domain profiles including information on components. The domain profile is described by several XML files for the purpose of the use of profiles.

FIG. 1 is a diagram illustrating the structure of an SCA (software communication architecture)-based core framework for an SDR terminal according to the related art.

A SCA-based core framework system for an SDR terminal includes a basic real time operating system (RTOS) 31 and CORBA middleware 30 defined by an SCA standard.

In the SCA-based core framework system, a reconfigurable core framework (RCF) 20 for supporting system reconfiguration is provided on the real time operating system 31 and the CORBA middleware 30. The reconfigurable core framework (RCF) 20 includes a file manager 21, a device manager 22, an application factory 23, a domain manager 24, and a parser manager 27. An application 10 is composed of a package of a plurality of components (component 1, . . . , N) 12, 13, and 14 connected to an assembly controller 11.

The application 10 uses an operator interface, which downloads an application package to the system, and arranges and executes the application package, in association with the domain manager 24 of the reconfigurable core framework (RCF) 20, to bind SW components into one application package, and arranges and executes an executable device. Application package information, component package information, component information are described in an XML file. In order to parse the XML file, each management component in the RCF (reconfigurable core framework) generates a parser class to obtain parsing information.

FIG. 2 is a diagram illustrating an example of a DTD file uses in a core framework for an SDR terminal according to the related art. The DTD (document type definition) file is deviceconfiguration.2.2.2, and a DCD XML file is created on the basis of the DTD file. The XML parser parses the content of the XML file on the basis of the DTD file.

FIG. 3 is a diagram illustrating an example of an XML file used in a core framework for an SDR terminal according to the related art. An Sdeu.dcd.xml file is a device configuration descriptor (DCD) file including information for executing the managers, which install and arrange applications, in the domain profile.

In the SCA technique according to the related art, a domain profile including information on SW components to be arranged is stored in seven types of XML files, and the core framework parses the domain profile to install and arrange an application. However, in this method, when the number of XML files increases, it requires a lot of time to parse the file, and the capacity of a parser required to parse the XML file increases. As a result, the performance of a terminal having limitations in resources is likely to be lowered.

Further, in the SCA standard according to the related art, the domain profile including information on SW components to be arranged is stored in the XML file, and the XML file including the domain profile is packed with the SW components to be arranged and then downloaded to the system. The core framework parses the XML file to be suitable for a DTD (document type definition) file, which is the template of an XML (extensible markup language) file, using a general parser, such as xerces, thereby acquiring information required to install and arrange the SW components.

However, in the core framework having the above-mentioned structure, the management components duplicately generate the same class in order to obtain parsing information, and repeatedly perform the same parsing process, which results in a waste of memory resources. In addition, the management components need to access files several times, which lowers the performance of a system.

### DISCLOSURE OF INVENTION

### Technical Problem

The invention is designed to solve the above problems, and an object of the invention is to provide a system and method for operating a domain profile using a database in an SCA (software communications architecture)-based core framework for an SDR terminal that is capable of reducing parsing time and improving the performance of a system by recoding a domain profile on a database text file, not an XML file, storing the database text file in a database, and rapidly searching the domain profile from the database, such that many managers, such as a file manager, a device manager, an application factory, a domain manager, and a database manager, can effectively obtain the parsing information in the SCA-based core framework for an SDR terminal.

### Technical Solution

In order to achieve the object, according to an aspect of the invention, there is provided a system for operating a domain profile in an SCA (software communications architecture)-based core framework for an SDR (software defined radio) terminal. The system includes a database manager that is arranged in a reconfigurable core framework (RCF), stores a database text file having a domain profile recorded thereon in a database, and searches the database text file.

The domain profile may include at least one of a domain profile related to a device package and a domain profile related to an application package.

The domain profile related to the device package may include at least one of a device configuration descriptor (DCD), a domain manager configuration descriptor (DMD), a device package descriptor (DPD), a software package descriptor (SPD), a software component descriptor (SCD), and a property descriptor (PRF).

The domain profile related to the application package may include at least one of a software assembly descriptor (SAD), a software package descriptor (SPD), a software component descriptor (SCD), and a property descriptor (PRF).

The reconfigurable core framework (RCF) may be operated on CORBA middleware.

The domain profile related to the device package may install and arrange the reconfigurable core framework (RCF), and then use the domain profile related to the application package to install a waveform application.

According to another aspect of the invention, there is provided a method of operating a domain profile using a database in a core framework for an SDR terminal. The method includes: (a) a step of allowing a database manager to receive, from a client, a database text file (sys_DB_textfile) having a domain profile related to a device package recorded thereon and to store the received database text file in the database; and (b) a step of allowing the database manager to receive, from the client, a database text file (app_DB_textfile) having a domain profile related to an application package recorded thereon to store the received database text file in the database, and to search the domain profile related to the application package.

The step (a) may include: (a1) a sub-step of executing the device manager at the request of the client, initializing the device manager, binding the device manager to a naming server in order to register the device manager, and executing a database manager; (a2) a sub-step of allowing the database manager to load the database text file (sys_DB_textfile) having the domain profile related to the device recorded thereon to the database to store initial data, and of binding the database manager to the naming server in order to register the database manager; and (a3) a sub-step of allowing the device manager to search information of a DCD (device configuration descriptor) file from the database manager and to execute an executable device module.

The step (b) may include: (b1) a sub-step of allowing the domain manager to install an application for the database text file (app_DB_textfile) having the domain profile related to the application package recorded thereon, at the request of the client; (b2) a sub-step of allowing the domain manager to parse an SAD file (app1_SAD.xml) to generate a new application factory, to receive application factory request information (getApplicationFactories) from the client, and to transmit, to the client, a list of the application factories that are currently installed (ApplicationFactoryList); and (b3) a sub-step of allowing the database manager to load the database text file (app_DB_textfile) having the domain profile related to the application package recorded thereon from the generated application factory to the database, thereby storing the database text file.

The step (b) may further include (b4) a sub-step of allowing the application factory to query the database manager for information of an SAD domain profile in order to obtain application configuration information, and to receive information of an SAD file from the database manager.

The step (b) may further include (b5) a sub-step of allowing the application to query the database manager for information of an SPD domain profile in order to obtain software package information, and to receive information of an SPD file from the database manager.

The step (b) may further include (b6) a sub-step of allowing the application factory query the database manager for information of an SCD domain profile in order to obtain information on an interface and a port of a component, and to receive information of an SCD file from the database manager.

The step (b) may further include (b7) a sub-step of allowing the application factory to use information obtained from the SAD, SPD, and SCD files to load all the components included in the files to positions specified in a terminal or to execute all the components.

### ADVANTAGEOUS EFFECTS

As described above, according to the above-described aspects of the invention, a domain profile is recorded on a database text file and then stored in a database, such that many managers, such as a file manager, a device manager, an application factory, a domain manager, and a database manager, can effectively obtain parsing information in an SCA (software communication architecture)-based core framework for an SDR terminal. Therefore, it is possible to reduce a waste of memory resources and rapidly search the domain profile from the database. As a result, it is possible to reduce parsing time and improve the performance of a system.

Further, unlike an XML parsing method according to the related art, the same class is not generated several times, and the same parsing process is not repeatedly performed several times. Therefore, it is possible to reduce a waste of memory resources and further improve the performance of a system, as compared to an XML parsing system according to the related art.

### BRIEF DESCRIPTION OF THE DRAWINGS

FIG. 1 is a diagram illustrating the structure of an SCA (software communication architecture)-based core framework for an SDR terminal according to the related art.

FIG. 2 is a diagram illustrating an example of a DTD file used in the core framework for an SDR terminal according to the related art.

FIG. 3 is a diagram illustrating an example of an XML file used in the core framework for an SDR terminal according to the related art.

FIG. 4 is a diagram illustrating the structure of an SCA-based core framework for an SDR terminal using a database according to an embodiment of the invention.

FIG. 5 is a diagram illustrating the relationship between an SCA domain profile and descriptors.

FIG. 6 is a diagram illustrating the mapping relationship between the kind of a domain profile related to a device package in a domain profile and a table name in a database.

FIG. 7 is a diagram illustrating the mapping relationship between the kind of a domain profile related to an application package in a domain profile and a table name in a database.

FIG. 8 is a diagram illustrating the mapping relationship between a table and a database indicating information of a DCD domain profile in a database related to a device (SYS_DB) according to an embodiment of the invention.

FIG. 9 is a service flowchart illustrating a process of installing a core framework for an SDR terminal according to the invention.

FIG. 10 is a service flowchart illustrating a process of installing an application and a process of generating an instance according to the invention.

### REFERENCE NUMERALS

10: application
11: assembly controller
12, 13, 14: component 1, 2, . . . , N
17a: database text file
20: reconfigurable core framework
21: file manager
22: device manager
23: application factory
24: domain manager
27a: database manager
30: CORBA middleware
31: RTOS (POSIX)

### BEST MODE FOR CARRYING OUT THE INVENTION

Hereinafter, exemplary embodiments of the invention will be described in detail with reference to the accompanying drawings.

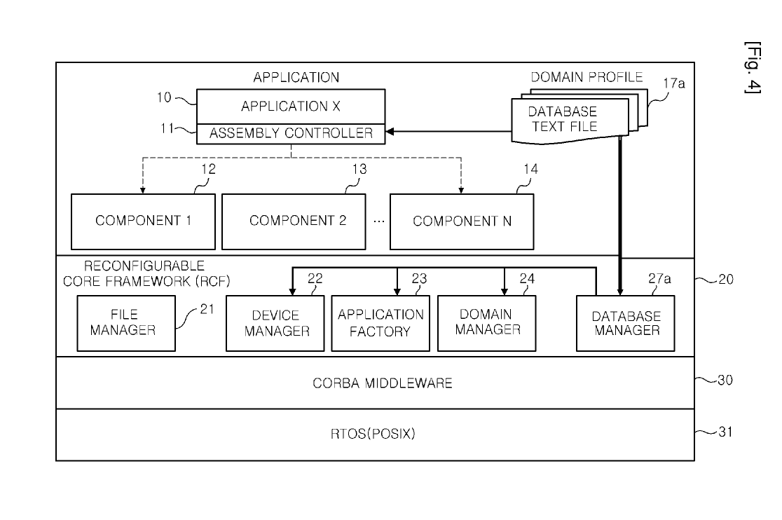

FIG. 4 is a diagram illustrating the configuration of an SCA-based core framework for an SDR terminal using a database according to an embodiment of the invention.

In the SCA-based core framework for an SDR terminal using the database, a reconfigurable core framework (RCF) 20 including a file manager 21, a device manager 22, an application factory 23, and a domain manager 24 is provided on a real time operating system (RTOS/POSIX) 31 and a CORBA middleware 30, and an application 10 on the RCF includes a plurality of components 12, 13, and 14 connected to an assembly controller 11.

The SCA-based core framework for an SDR terminal using the database includes: a database text file 17a that records a domain profile related to a device package or a domain profile related to an application package; and a database manager 27a that stores the database text file 17a having the domain profile recorded thereon in a database and provides a search function.

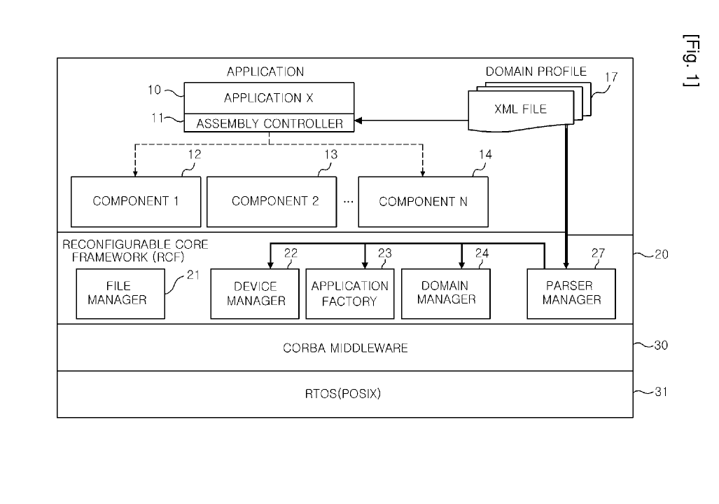

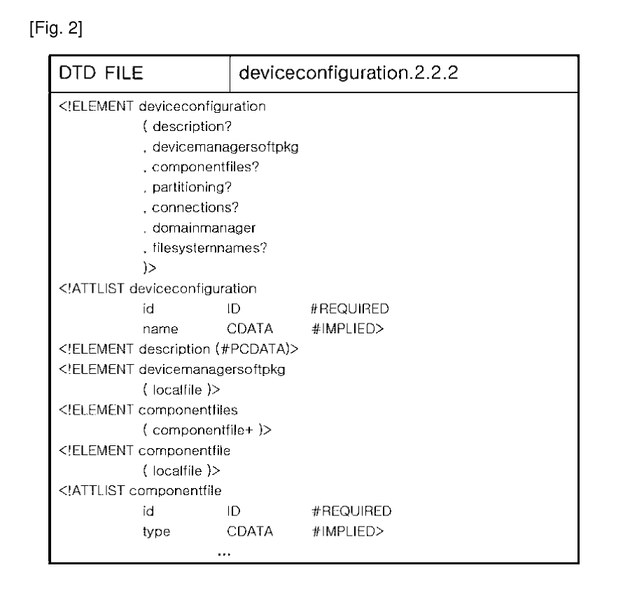

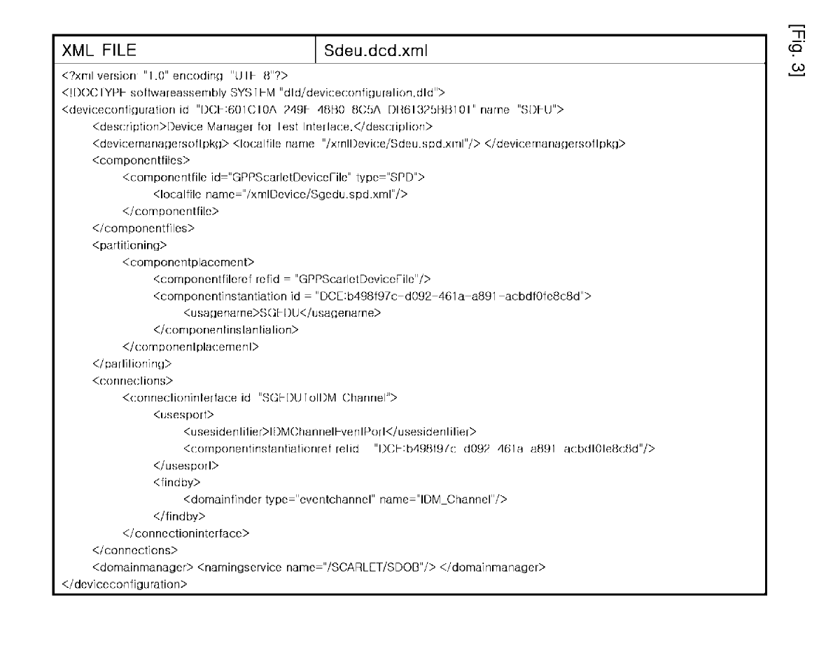

The overall structure of the SCA-based core framework for an SDR terminal using the database is similar to that shown in FIG. 1 except that domain profiles for a device package and an application package are not recorded on an XML file, but the database manager 27a stores the database text file 17a having the domain profile recorded thereon in the database.

The core framework for an SDR terminal uses a profile related to the device package to install the reconfigurable core framework (RCF) at the beginning, and then uses a domain profile related to an application package to install a waveform application.

The core framework for an SDR terminal uses a general search method in order to extract a domain profile from the database.

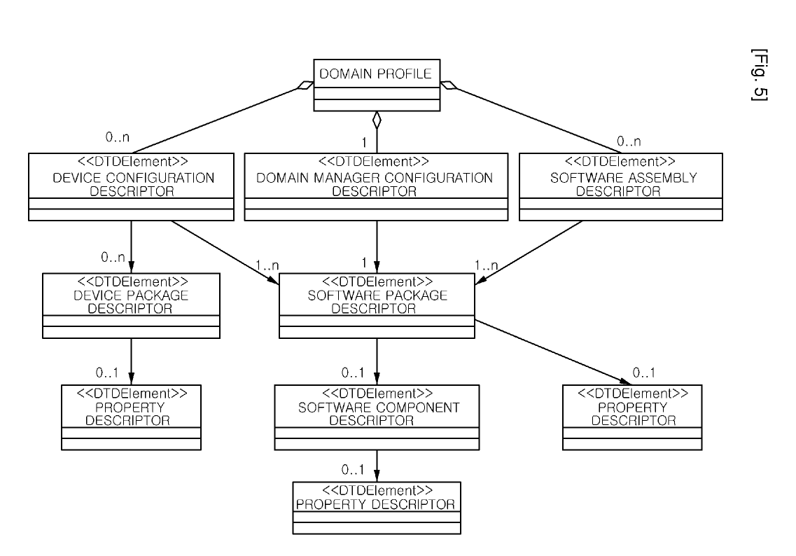

FIG. 5 is a diagram illustrating the relationship between an SCA domain profile with descriptors.

A HW device and a SW component forming an SCA system domain are described by a set of XML descriptor files referred by the domain profile. The SCA domain profile includes a total of seven types of descriptor files. These descriptor files describe an identifier, capability, a property, and an interdependent relationship, according to the type of each component.

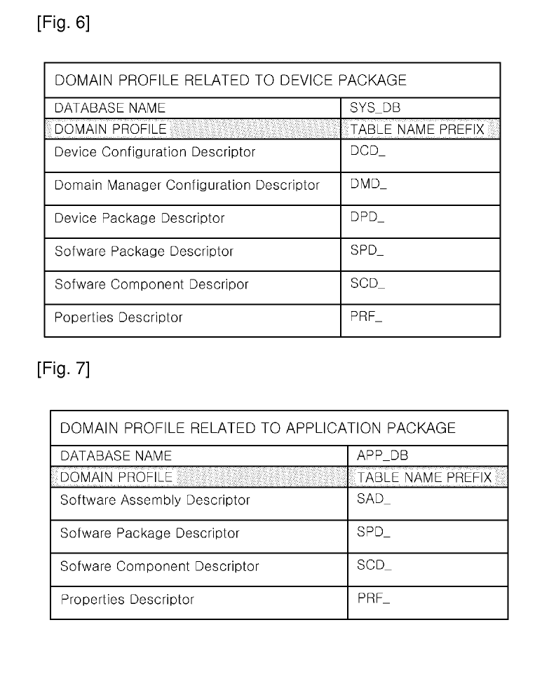

FIG. 6 is a diagram illustrating the mapping relationship between the kind of domain profile related to the device package in the domain profile and a table name in the database.

The database name related to a device is SYS_DB, and a table related to each profile is configured using a table name prefix shown in the table.

The domain profile related to the device package includes a device configuration descriptor (DCD), a domain manager configuration descriptor (DMD), a device package descriptor (DPD), a software package descriptor (SPD), a software component descriptor (SCD), and a property descriptor (PRF).

A device configuration descriptor (DCD) file includes information on a device associated with the device manager, a method of finding a domain manager, and configuration information of each device.

A domain manager configuration descriptor (DMD) file includes configuration information of a domain manager.

A device package descriptor (DPD) file identifies the class of a device and includes specific properties for the class.

A software package descriptor (SPD) file includes a package name of a software package, a package developer, a property file and implementation code information, and general information on the independence between HW and SW.

A software component descriptor (SCD) file includes information on a specific SCA software component, such as a resource, a resource factory, or a device.

A property descriptor (PRF) file includes information on component properties, such as configuration, test, execution, and allocation type.

FIG. 7 is a diagram illustrating the mapping relationship between the kind of domain profile related to an application package in the domain profile and a table name in the database.

An application database name is APP_DB, and a table related to each profile is configured using a table name prefix shown in the table.

A domain profile related to the application package includes a software assembly descriptor (SAD), a software package descriptor (SPD), a software component descriptor (SCD), and a property descriptor (PRF).

A software assembly descriptor (SAD) file includes information on components forming an application.

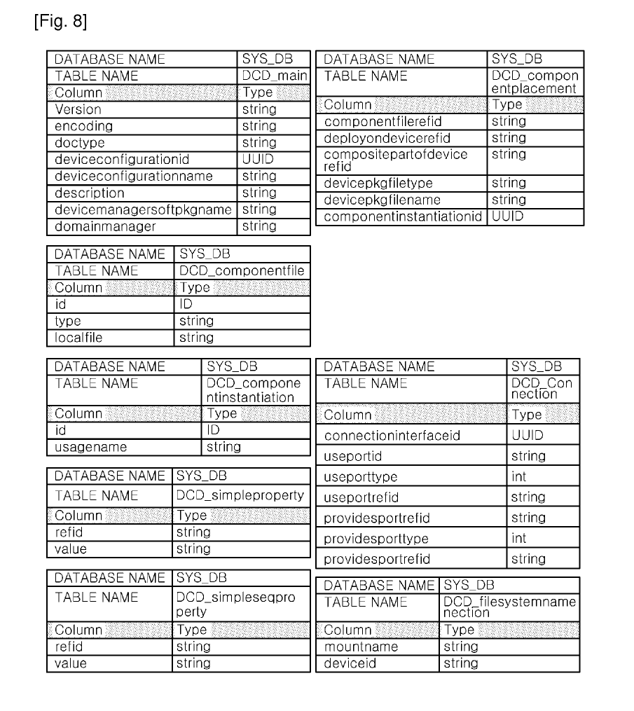

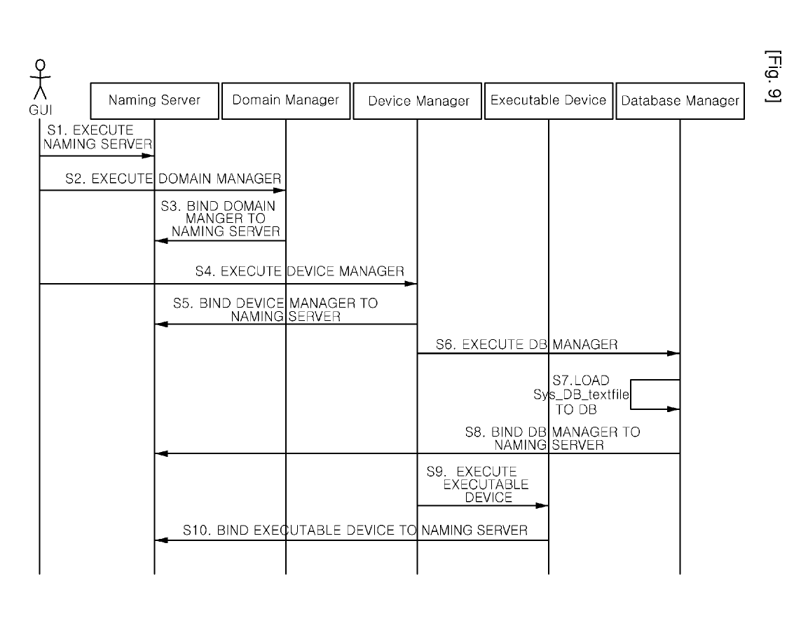

FIG. 8 is a diagram illustrating the mapping relationship between a database indicating information on a DCD domain profile and a table in a database SYS_DB related to a device according to an embodiment of the invention.

Databases are classified into the database SYS_DB related to a device and an application database APP_DB. FIG. 8 shows several tables indicating information on a DCD (device configuration descriptor) domain profile in the SYS_DB. In the XML file, an element or an attribute is mapped to a column of the table.

A method of operating a domain profile using a database in the core framework for an SDR terminal includes: (a) a step of allowing the database manager 27a to receive a database text file sys_DB_textfile having a domain profile related to a device package from a user client the device manager 22 and to store the received file in the database; and (b) a step of allowing the database manager 27a to receive a database text file app_DB_textfile having a domain profile related to an application package from the user client through the domain manager 24 and the application factory 23, to store the received file in the database, and to search the domain profile related to the application package.

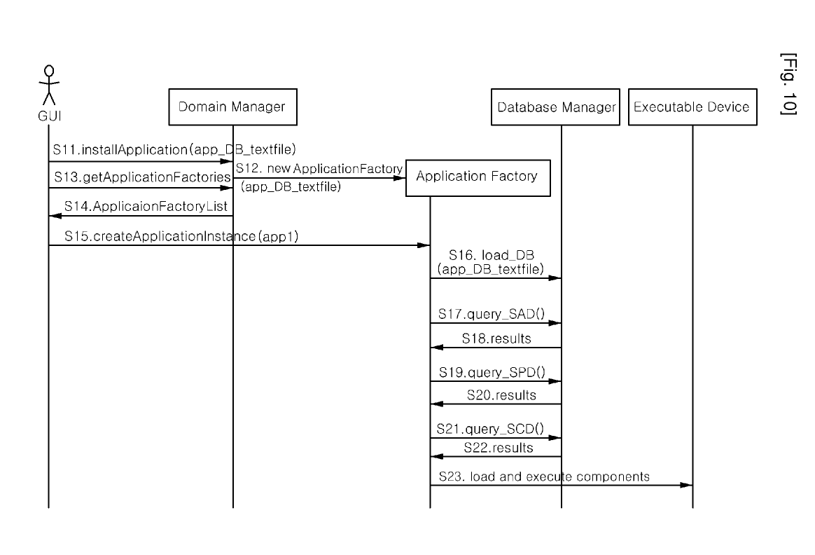

FIG. 9 is a service flowchart illustrating a process of installing the core framework for an SDR terminal according to the invention.

The user client executes a naming server in order to use CORBA middleware (S1), and then executes the domain manager 24 (S2).

The domain manager 24 performs an initializing process, and is bound to the naming server in order to register the domain manager 24 in the naming server (S3).

The user client executes the device manager 22 (S4).

The device manager 22 performs an initializing process, and is bound to the naming server in order to register the device manager 22 in the naming server (S5). Then, the device manager 22 executes the database manager (hereinafter, referred to as a DB manager) 27a (S6).

The DB manager 27a loads the database text file sys_DB_textfile having the domain profile related to the device package recorded thereon to the DB, and stores initial data (S7).

The DB manager 27a performs an initializing process, and is bound to the naming server in order to register the DB manager 27a in the naming server (S8).

The device manager 22 searches information of a DCD (device configuration descriptor) file from the DB manager 27a, and executes an executable device module (S9).

The executable device module performs an initializing process, and is bound to the naming server in order to register the executable device module in the naming server (S10).

FIG. 10 is a service flowchart illustrating a process of installing an application and a process of generating an instance according to the invention.

The user client controls the domain manager 24 to execute installApplication(app_DB_textfile) to install an application for the database text file app_DB_textfile having the domain profile related to the application package (S11).

The domain manager 24 parses an SAD file app1_SAD.xml to generate a new application factory 23, and verifies files specified in the SAD file app1_SAD.xml (S12).

The user client transmits, to the domain manager 24, factory request information (getApplicationFactories) for the application that is currently installed (S13).

The domain manager 24 transmits, to the user client, a list of the application factories (ApplicationFactoryList) that are currently installed (S14).

The user client selects a specific application factory 23 and generates a specific application app1 using createApplicatonInstance(app1) (S15).

The application factory 23 controls the DB manager 27a to load the database text file app_DB_textfile having the domain profile related to the application package recorded thereon to the DB (load_DB(app_DB_textfile)) and stores information of the domain profile related to the application package (S16).

The application factory 23 queries the DB manager 27a for information on the SAD domain profile using query_SAD( ) in order to obtain application configuration information (S17).

The DB manager 27a transmits to the application factory 23 information of the SAD file in response to the query (S18).

The application factory 23 queries the DB manager 27a for information on an SPD domain profile using query_SPD( ) in order to obtain software package information (S19).

The DB manager 27a transmits to the application factory 23 information of an SPD file in response to the query (S20).

The application factory 23 queries the DB manager 27a for information of an SCD domain profile using query_SCD( ) in order to obtain information on an interface and a port of a component (S21).

The DB manager 27a transmits to the application factory 23 information of an SCD file in response to the query (S22).

The application factory 23 uses information obtained from the SAD (software assembly descriptor) file, the SPD (software package descriptor) file, and the SCD (software component descriptor) file to load all the components included in the files at the positions specified in the terminal or to execute the all the components (S23).

The domain profile operating system using the database according to the invention can be applied to all systems having the SCA structure. As a representative example, an SDR (software defined radio) terminal uses such an SCA structure to support multiple modes and to perform reconfiguration.

In order to effectively obtain parsing information, the managers in the core framework configures the domain profiles related to the device and application as a DB text file, instead of the XML file. Then, when uploading the application to the terminal, the managers first load the database text file to the database (DB) and store the database text file. The managers in the core framework for an SDR terminal acquire the domain profiles related to the device and application from the database, and arrange the components in the application at proper positions for execution.

In stead of recording the domain profile on the XML file, the domain profile operating system using the database in the core framework for an SDR terminal stores a DB text file in the database, and other management components in the core framework rapidly search the domain profiles from the database. Therefore, it is possible to shorten parsing time and improve the performance of the system.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A system for operating a domain profile in an SCA (software communications architecture)-based core framework for an SDR (software defined radio) terminal, the system comprising:
a database manager that is arranged in a reconfigurable core framework (RCF), stores a database text file having a domain profile recorded thereon in a database, and searches the database text file.

2. The system of claim 1,
wherein the domain profile includes at least one of a domain profile related to a device package and a domain profile related to an application package.

3. The system of claim 2,
wherein the domain profile related to the device package includes at least one of a device configuration descriptor (DCD), a domain manager configuration descriptor (DMD), a device package descriptor (DPD), a software package descriptor (SPD), a software component descriptor (SCD), and a property descriptor (PRF).

4. The system of claim 2,
wherein the domain profile related to the application package includes at least one of a software assembly descriptor (SAD), a software package descriptor (SPD), a software component descriptor (SCD), and a property descriptor (PRF).

5. The system of claim 1,
wherein the reconfigurable core framework (RCF) is operated on CORBA middleware.

6. The system of claim 2,
wherein the domain profile related to the device package installs and arranges the reconfigurable core framework (RCF), and then uses the domain profile related to the application package to install a waveform application.

7. A method of operating a domain profile using a database in a core framework for an SDR terminal, the method comprising:
(a) a step of allowing a database manager to receive, from a client, a database text file (sys_DB_textfile) having a domain profile related to a device package recorded thereon and to store the received database text file in the database; and
(b) a step of allowing the database manager to receive, from the client, a database text file (app_DB_textfile) having a domain profile related to an application package recorded thereon, to store the received database text file in the database, and to search the domain profile related to the application package.

8. The method of claim 7,
wherein the step (a) includes:
(a1) a sub-step of executing the device manager at the request of the client, initializing the device manager, binding the device manager to a naming server in order to register the device manager, and executing a database manager;
(a2) a sub-step of allowing the database manager to load the database text file (sys_DB_textfile) having the domain profile related to the device recorded thereon to the database to store initial data, and of binding the database manager to the naming server in order to register the database manager; and
(a3) a sub-step of allowing the device manager to search information of a DCD (device configuration descriptor) file from the database manager and to execute an executable device module.

9. The method of claim 7,
wherein the step (b) includes:
(b1) a sub-step of allowing the domain manager to install an application for the database text file (app_DB_textfile) having the domain profile related to the application package recorded thereon, at the request of the client;
(b2) a sub-step of allowing the domain manager to parse an SAD file (app1_SAD.xml) to generate a new application factory, to receive application factory request information (getApplicationFactories) from the client, and to transmit, to the client, a list of the application factories that are currently installed (ApplicationFactoryList); and
(b3) a sub-step of allowing the database manager to load the database text file (app_DB_textfile) having the domain profile related to the application package recorded thereon from the generated application factory to the database, thereby storing the database text file.

10. The method of claim 9,
wherein the step (b) further includes:
(b4) a sub-step of allowing the application factory to query the database manager for information of an SAD domain profile in order to obtain application configuration information, and to receive information of an SAD file from the database manager.

11. The method of claim 9,
wherein the step (b) further includes:
(b5) a sub-step of allowing the application to query the database manager for information of an SPD domain profile in order to obtain software package information, and to receive information of an SPD file from the database manager.

12. The method of claim 9,
wherein the step (b) further includes:
(b6) a sub-step of allowing the application factory query the database manager for information of an SCD domain profile in order to obtain information on an interface and a port of a component, and to receive information of an SCD file from the database manager.

13. The method of claim 9,
wherein the step (b) further includes:
(b7) a sub-step of allowing the application factory to use information obtained from the SAD, SPD, and SCD files to load all the components included in the files to positions specified in a terminal or to execute all the components.
